(19) United States
(12) Patent Application Publication
(10) Pub. No.: US 2010/0052410 A1
(43) Pub. Date: Mar. 4, 2010

(54) Stackable Bicycle Wheels

(76) Inventors: Aleksandr Sherman, Brooklyn, NY (US); Sergey Zvonik, Brooklyn, NY (US)

Correspondence Address: Israel Nissenbaum, 1038 56th Street, Brooklyn, NY, 11219, US

(21) Appl. No.: 12/514,418

(22) PCT Filed: Sep. 8, 2008
(86) PCT No.: PCT/US08/75648

§ 371 Date: May 11, 2009

Related U.S. Application Data
(60) Provisional application No. 60/970,521, filed on Sep. 6, 2007.

(51) Int. Cl. B60B 1/02; B60B 35/00; B65G 57/00

(52) U.S. Cl. 301/55; 301/126; 414/802

(57) ABSTRACT

A wheel with a removable hub axle cartridge configured to be fitted into a shaped recess hollow or cavity of the wheel at the central hub position. The hub axle cartridge, adapted for use with a rear wheel includes a clutch mechanism and is configured for supporting drive gears, in addition to providing engagement with the body frame for a front wheel. The removable hub axle cartridge provides various advantages including a reduced wheel weight, the ability to stably stack, store and ship the wheels in smaller packages. The hub axle cartridge is reusable in case of wheel damage or with use of a different wheel type.

This invention relates to bicycle wheels and particularly to bicycle wheels which are easily removable from a frame and are stably stackable.

### BACKGROUND OF THE INVENTION

Bicycle wheels, both front and rear wheels, are generally constructed with an integrated central hub axle. The central hub axles of both front and rear wheels comprise unitary or sectioned rod members which are integrated with the wheel to connect to the wheel frame and to permit rotation with a front wheel or with an additional transmission arrangement such as a drive chain and a clutch member with a rear wheel. Of necessity, elements of the hub axle rod members extend out of the plane of the wheel for engagement with at least a forked section of the bicycle frame. As a result of the hub axle rod member extension, wheels cannot be stably stacked. Accordingly, packing, storing and transporting of bicycle wheels which have been removed from the bicycle is awkward, and the hub axle rods can pierce packaging and requires excessive volume. In addition, rear and front wheels are not interchangeable since they have integrated hub axles with and without drive transmissions respectively. Rear wheels and front wheels are accordingly separately produced and handled

### SUMMARY OF THE INVENTION

It is accordingly an object of the present invention to provide bicycle wheels which are stably stackable for moving and storage.

It is a further object of the present invention to provide a bicycle wheel with a hub axle which is removable as a unit or cartridge to provide relatively planar wheel surfaces suitable for stacking.

It is yet another object of the present invention to provide the removable hub axle cartridge whereby a single wheel type can be used for both front and rear wheel of a bicycle when used with front and rear wheel cartridges respectively.

Another object of the present invention is to provide removable hub axle cartridges which are re-usable if the wheel becomes broke or bent with considerable replacement cost savings. The hub axle cartridges may also be used with other types of wheels (mountain, off road, racing, etc.) if desired

It is still yet another object of the present invention to provide methods for stably stacking, storing and transporting bicycle wheels and for permitting generic wheels to be used for both front and rear wheels of bicycles with removable cartridge hub axles with different characteristics.

Generally the present invention comprises a bicycle wheel (the term “wheel” as used herein refers to a wheel rim, irrespective of tires) with a removable rotatable hub axle; the removable hub axle, as a separate cartridge element either configured for front or rear wheel use; and a method for permitting bicycle wheels to be stably stacked for facilitated storage, handling and shipment. The present invention further comprises a method for utilization of the same wheel for both front and rear wheel with the selective use of front and rear wheel hub axle cartridges.

In accordance with the present invention the wheel is configured with a recessed hub receptacle conformed to the shape of the hub axle cartridge for releasably mating therewith. The wheel further comprises releasable cooperative holding elements for use in providing a secure holding between wheel and hub axle cartridge during use of the bicycle, with the holding elements being released for removal of the hub axle cartridge.

The hub axle comprises a removable unitary cartridge member configured as an elongated rod element and adapted to be fitted into and removable from a shaped recess hollow or cavity of the wheel at the central hub position. The front and rear wheels of a bicycle may be identical but made to differ in function depending on the type of removable axle hub cartridge used therewith. Hub axle cartridges used with either front or rear bicycle wheels are provided with extensions for engagement with the body frame. In addition, a hub axle cartridge adapted for use with a rear wheel includes a clutch mechanism and is configured for supporting drive gears, in addition to providing engagement with the body frame.

The hub axle element of either the front wheel or rear wheel is configured to be fittingly inserted into a hub cavity and affixed to the wheel such as with a series of small bolts. In a preferred embodiment the hub axle element comprises an integral circular flange having a circumferential series of through apertures into which the small bolts are threaded for threaded holding engagement with threaded apertures in the hub cavity of hollow of the wheel. The hub axle cartridge is readily removed from the wheel by simple removal of the series of small bolts.

The removable hub axle cartridge structure provides various advantages, including a reduced wheel weight, the ability to store and ship the wheels in smaller packages, as a result of stackability with the hub axle cartridge component being removed, and separately packaged. In addition wheels can be produced and stored in a single generic configuration, with the type of inserted hub axle element determining front or rear wheel function. The hub axle cartridge structure is also amenable to reuse with the often occurring damage to a wheel, with significant cost savings. In addition, the hub axle cartridge is usable with different wheel types, as desired such as Road/Mountain/Hybrid/Touring/Recumbent/Tandem etc, using the same axle-hub cartridge.

The method of the present invention comprises the steps of:
1) providing a bicycle wheel with a central hub cavity,
2) forming a separable self contained hub axle cartridge with either the drive components of the front and rear wheel,
3) forming the self contained hub axle cartridge with elements for connection between the wheel and the bicycle frame, and
4) connecting the hub axle cartridge to the wheel and the bicycle frame for use of the bicycle and disconnecting the hub cartridge from the bicycle wheel and bicycle frame for stacked storage or transport of bicycle wheels or reuse of the hub axle cartridge.

In a method for providing a rear or front bicycle wheel, in step 2 above, the self contained hub axle cartridge is formed with either the frame connection components of a front wheel or additional drive elements of a rear wheel, as desired. In a further modification, the hub axle cartridge may be provided with elements for engaging the bicycle frame on one side or on both sides of the wheel

Other objects, features and advantages of the present invention will become more evident form the following discussion and drawings in which:

### SHORT DESCRIPTION OF THE DRAWINGS

FIG. 1 is a partial side view of a wheel of the present invention with the hub axle removed and showing the hub recess or cavity and threaded bolt holes;

FIG. 1a is a wheel with the frame fork mounted to ends of the hub axle cartridge on both sides of the wheel;

FIG. 1b is a wheel mounted to the hub axle cartridge on one side of the wheel;

FIG. 2 is a more detailed section view of the hub axle cartridge on the rear wheel of FIG. 1a;

FIG. 3 is a more detailed section view of the rear wheel with the hub axle cartridge being mounted only from one side of the wheel as in FIG. 1b;

FIG. 4 is a cross section view of the front wheel hub axle cartridge in accordance with the present invention, and as mounted on the frame;

FIG. 5 is a detailed cross section view of the rear mounted hub axle cartridge with further mounting of the wheel to the drive mechanism of the rear wheel:

FIG. 6 is a view of the hub axle cartridge as removed from the wheel;

FIG. 7 is a top view of the hub cavity of the wheel with threaded bolt holes;

FIG. 8 depicts placement of the hub axle cartridge into the hub cavity of the wheel;

FIG. 9 depicts the hub axle cartridge partially inserted into the hub cavity of the wheel;

FIG. 10 is a perspective view of two stacked wheels in a planar minimum volume juxtaposition; and

FIG. 11, depicts the stacked wheels of FIG. 10 being packed in a box for shipment.

### DETAILED DESCRIPTION OF THE INVENTION AND DRAWINGS

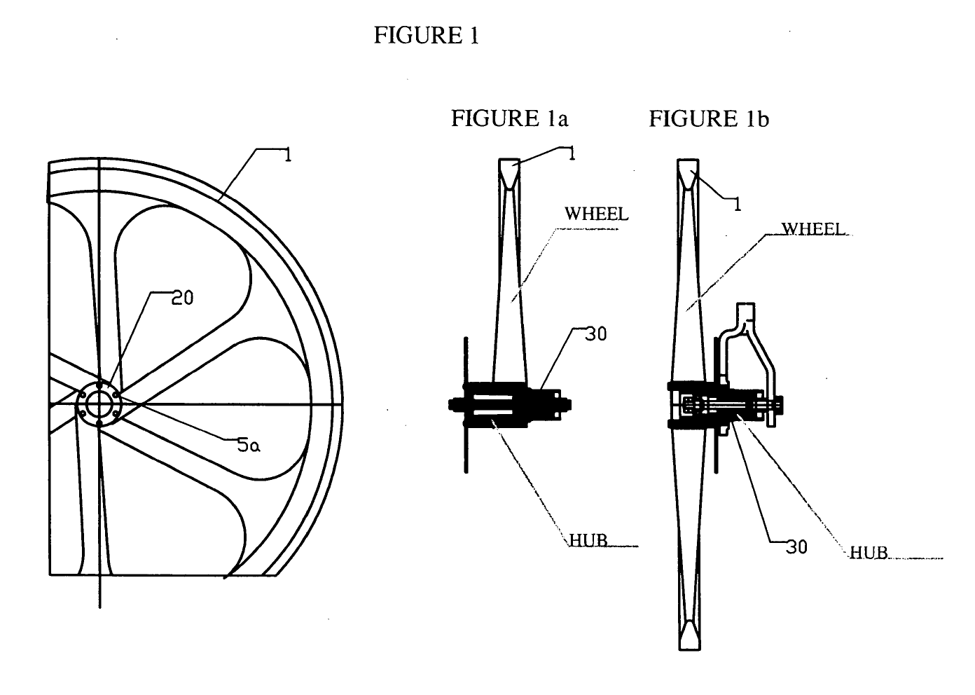

With respect to the drawings, FIG. 1 is a partial view of wheel 1 of the present invention with a central hollow hub cavity 20. Depending on the relative configuration of the hollow 1 and separate hub axles 30 and 30′, shown in FIGS. 1a and 1b respectively the hub axles 30 and 30′ respectively extend beyond both sides of the wheel (FIG. 1a) for engagement with a forked bicycle frame or on one side of the wheel (FIG. 1b) for engagement with a bicycle frame support 13 with a single forked configuration for use on one side of the wheel. Hub axles 30 and 30′ are configured for use with the rear or driving wheel of a bicycle.

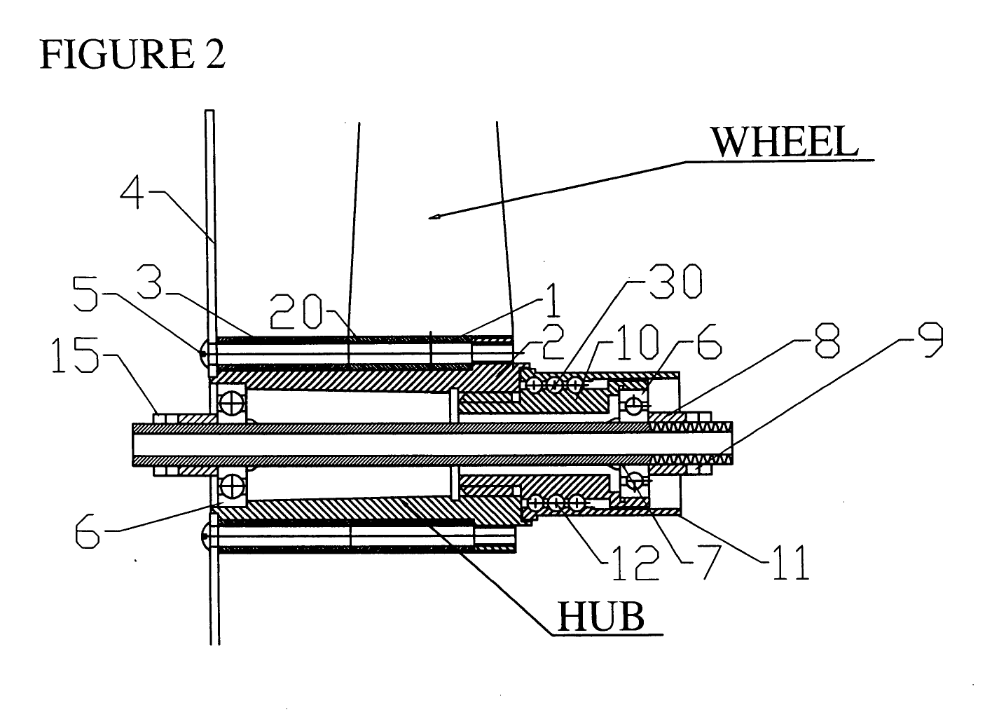

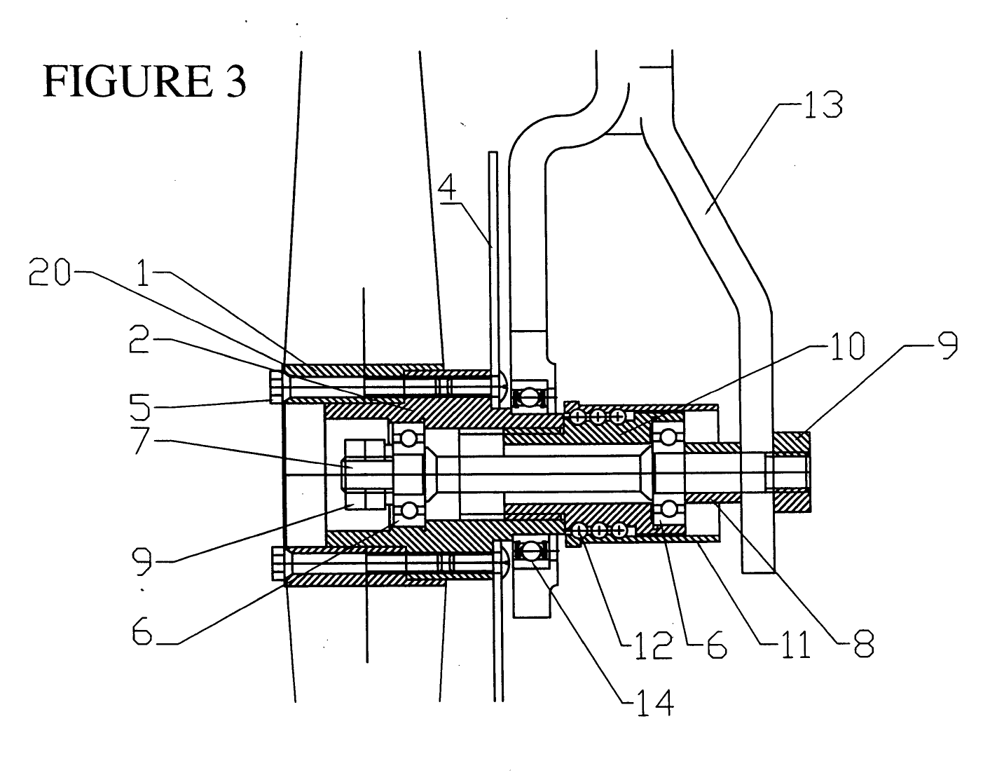

FIGS. 2 and 3 show the wheels of FIGS. 1a and 1b respectively in blow-up detail, showing how the respective hub axles 30 and 30′ are affixed to the wheel hub hollow 20 by threaded insertion of six bolts 5 (two shown) into the threaded holes 5a of the wheel hub shown in FIG. 1. In FIG. 2, insertion of the hub axle 30 is shown as being through the wheel hub 20 from the left, as is the bolt affixation. The body of the hub axle 3 is stopped by the wheel hub 20 into correct position with protrusion of the ends 15 from either side for engagement of a forked frame support member (not shown) and the gearing mechanism for connection to a chain (not shown). In FIG. 3 there is only a single elongated protrusion 15 to the right for engagement with frame support member 13 and for holding the drive gearing clutch element cartridge 11. Clutch element 11 is comprised of body 10, and bearing 12.

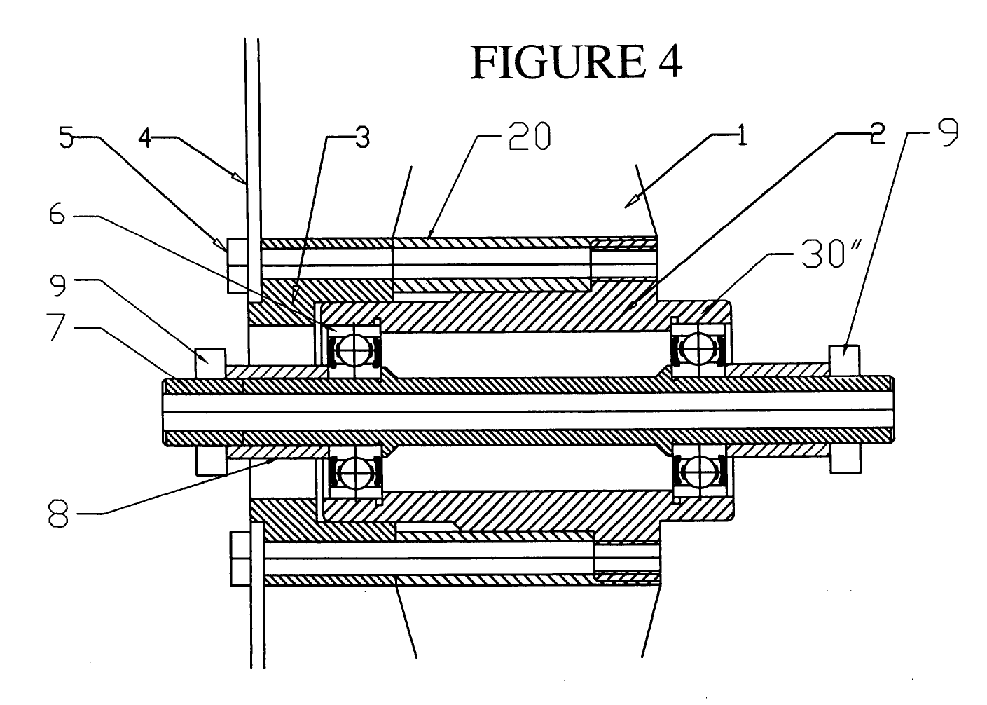

FIG. 4 is a partial sectioned view of the hub axle cartridge 30″ as adapted for front wheel use and is positioned on a hub or rim 20 of the wheel of a bicycle and is similarly held thereon with bolts 5.

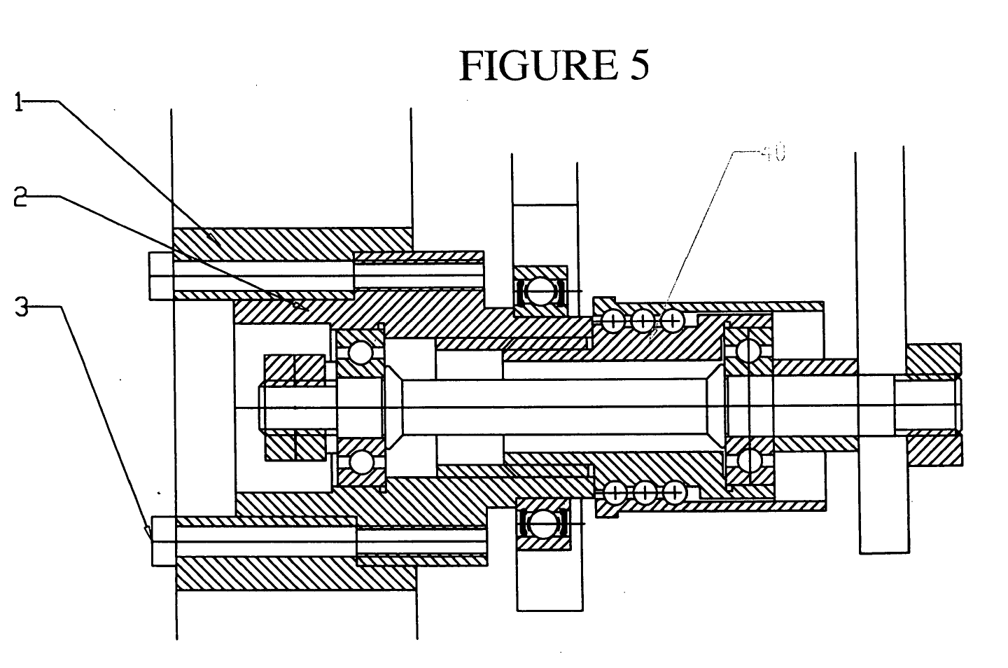

FIG. 5 shows the mounting of the wheel hub to the drive mechanism 40 of the rear wheel. All the elements of the respective hub axles, which are included in this mechanism, remain within the hub axle cartridge body 2, on the bicycle and are not made for disassembly and assembly when the wheel and hub axles are separated, by removal of all the bolts.

The elements of the respective hub axles 30, 30′ and 30″ shown in FIGS. 2, 3 and 4 respectively are common and are designated with the same reference numbers. Remote bushing 3 is used when the bicycle utilizes disc brakes with disk brake rotor 4. Bearings 6 contain and support the wheel axle 7 for rotational movement. Bushings 8 are positioned adjacent ends of axle 7 and are held in place with nuts 9.

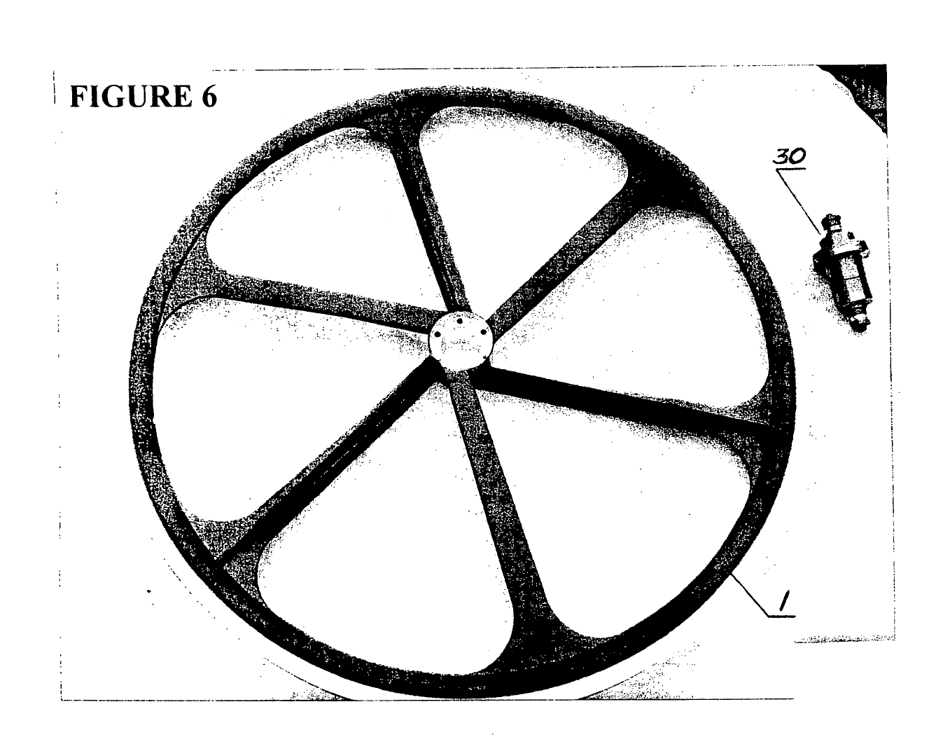

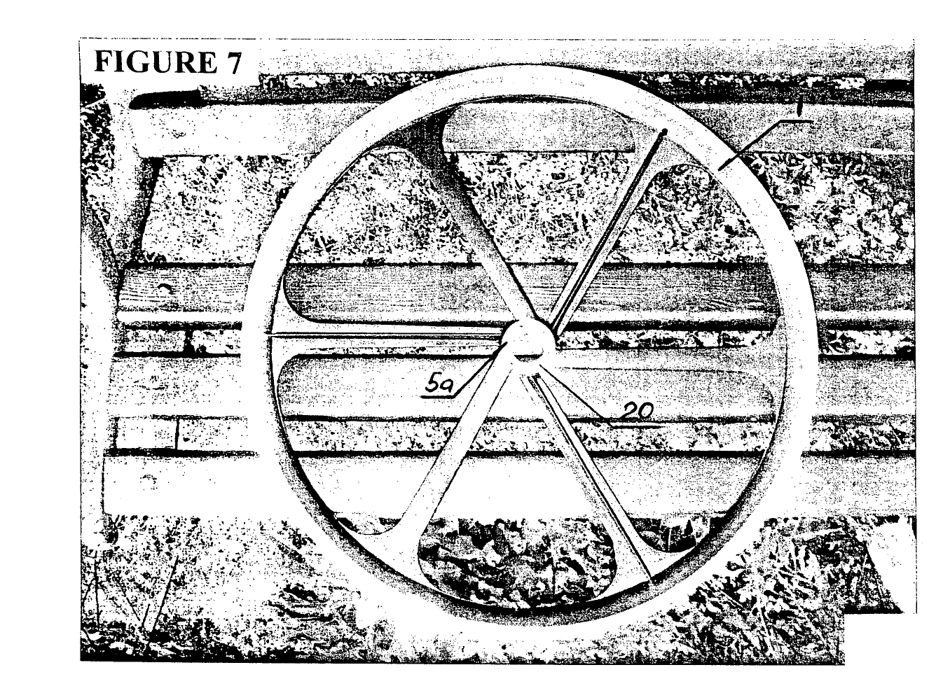

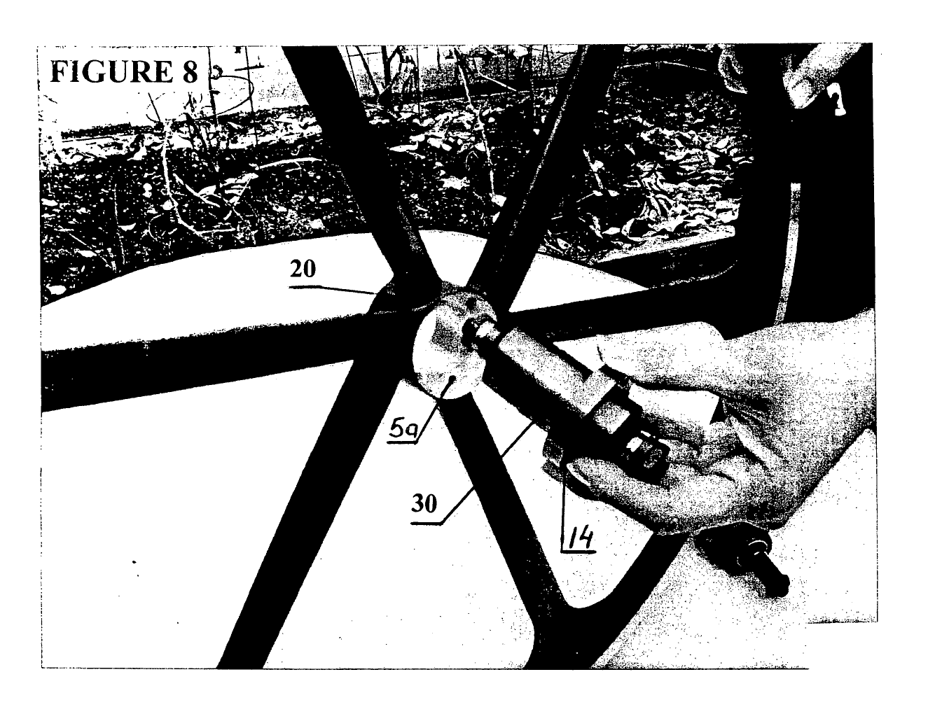

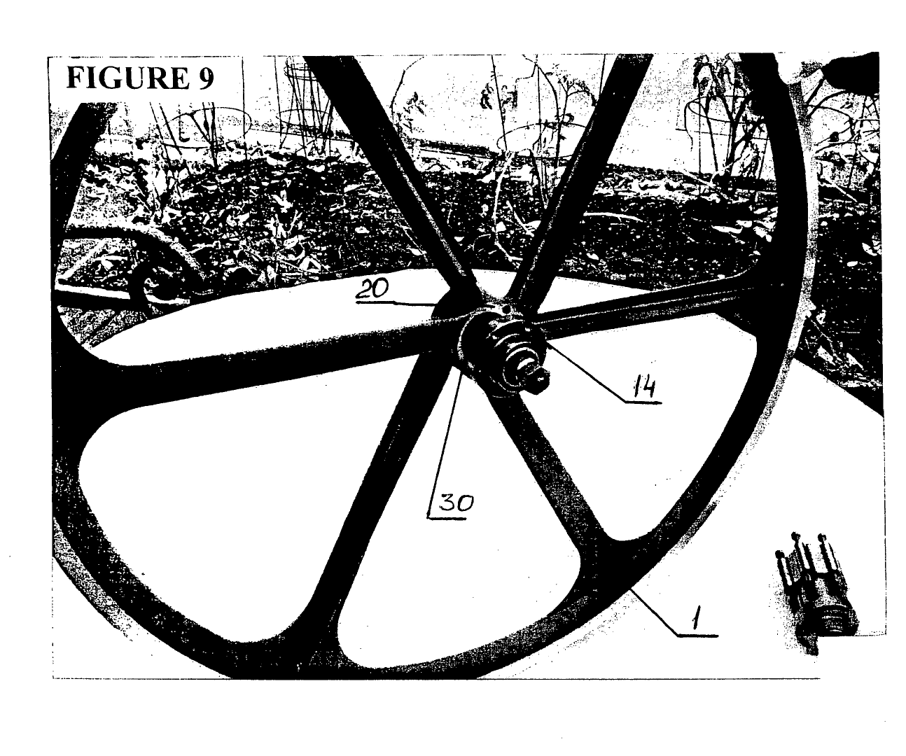

FIGS. 6 and 7 depict the separated hub axle cartridge 30 and wheel 1 with hub hollow 20 and threaded bolts holes 5a in the hub hollow. FIGS. 8 and 9 further depict emplacement and attachment between the hub axle cartridge 30 and the wheel 1 with alignment of through holes 5b in flange 14 of the hub axle cartridge and the threaded retaining bolt holes 5a and subsequent placement of bolts 5.

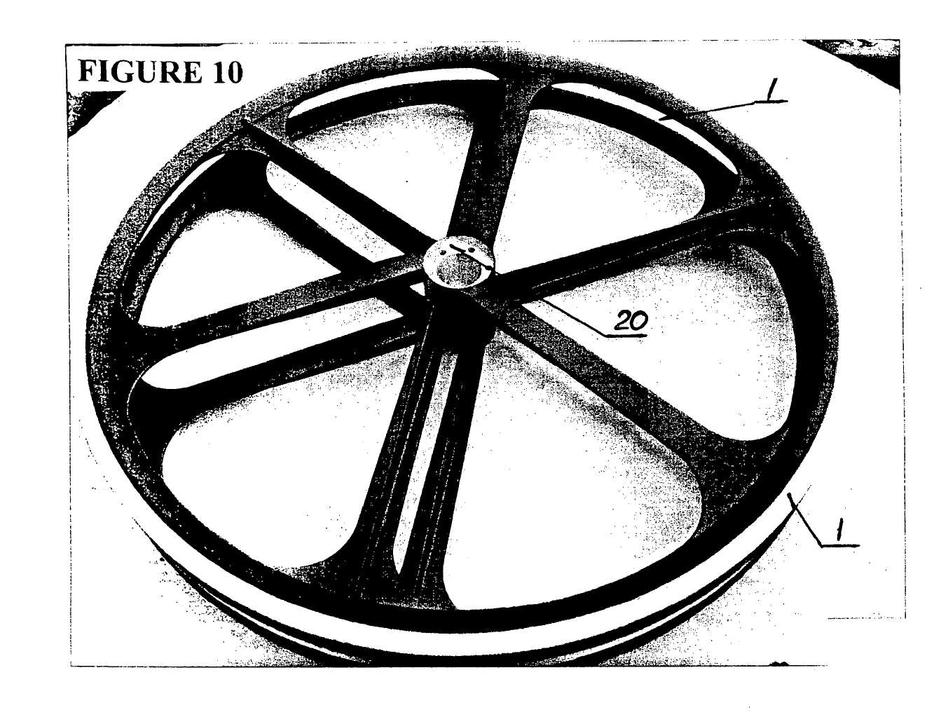

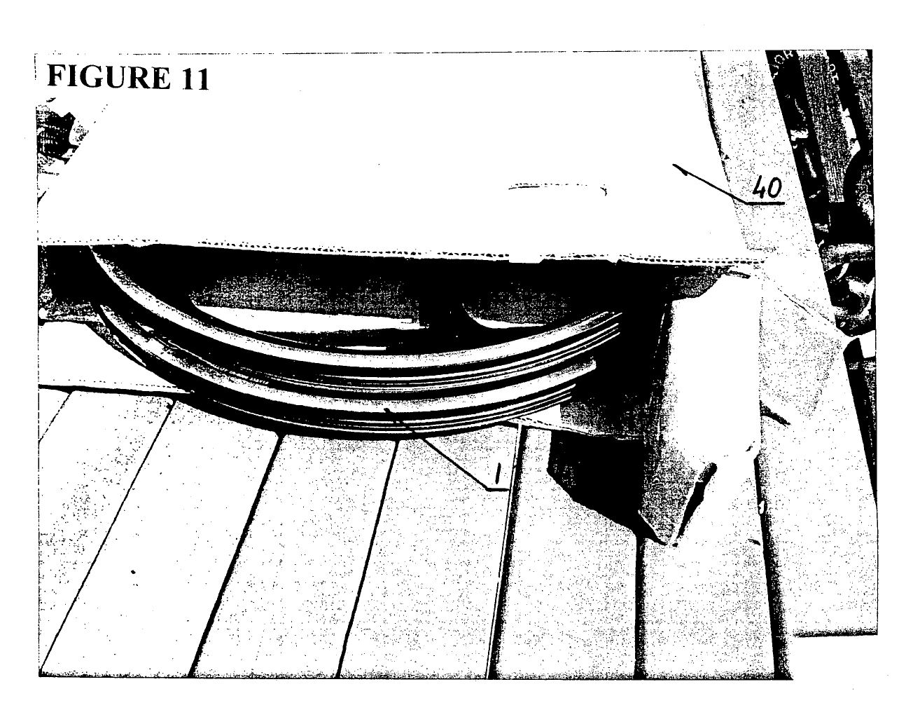

With removal of the hub axle cartridge 30 from the wheel 1, the sides of the wheel are essentially planar and wheels are stably stackable as shown in FIG. 10 with a minimal profile whereby they can be readily enclosed in a thin flat storage or transport case 40 shown in FIG. 11.

The components of the present invention are comprised of standard materials and are preferred to be of light weight but sturdy metal and/or engineering plastics. These include any and all type of material (steel, aluminum, carbon, titanium, etc) which are used today or can be used in the future. It is understood however, that the above description and specific illustrated embodiments are only exemplary of the present invention and that changes may be made to structure and components without departing from the scope of the present invention as defined in the following claims.

What is claimed is:

1. A bicycle wheel having a hollow central hub adapted to conform to a hub axle cartridge for the removable holding thereof, wherein the hub axle cartridge is held in operative axle position in said wheel hub by removable fastening members and wherein the hub axle cartridge protrudes from a side of the wheel for engagement with a frame support member of the bicycle for connection of the wheel to a bicycle frame.

2. The bicycle wheel of claim 1, wherein the bicycle wheel is also configured for the removable holding of a hub axle cartridge which further contains a drive mechanism for the wheel, with the wheel and hub axle cartridge being configured to function as a rear wheel for the bicycle.

3. The bicycle wheel of claim 1 wherein the hub axle cartridge is configured for engagement with the bicycle wheel to function as a front bicycle wheel.

4. A hub axle cartridge adapted for use with a bicycle wheel having a hollow central hub with the hub axle cartridge being configured for placement and removable engagement with the wheel within the hollow central hub, the hub axle cartridge comprising a fully contained rotating axle member for the wheel and is configured for supporting attachment with a bicycle frame element to operatively connect a bicycle frame and the wheel.

5. The hub axle cartridge of claim 4, wherein the hub axle cartridge further comprises a clutch drive mechanism for use in driving the wheel when connected therewith.

6. The hub axle cartridge of claim 4, wherein the hub axle cartridge is usable with a plurality of wheels.

7. A bicycle wheel with a removable rotatable hub axle; the removable hub axle, comprising a separate cartridge element configured for use as a hub and axle for one of front and rear bicycle wheel use.

8. The bicycle wheel of claim 7, wherein the wheel is configured with a recessed hub receptacle conformed to the shape of the hub axle cartridge for releasably mating therewith, the wheel further comprising releasable cooperative holding elements adapted to provide a secure holding between wheel and hub axle cartridge during use of the bicycle, with the holding elements being released for removal of the hub axle cartridge.

9. The bicycle wheel of claim 8, wherein the hub axle is configured to be fittingly inserted into a hub cavity and affixed to threaded apertures in the wheel hub with a series of small bolts.

10. The bicycle wheel of claim 9 wherein the hub axle cartridge comprises an integral circular flange having a circumferential series of through apertures into which the small bolts are threaded for threaded holding engagement with threaded apertures in the hub cavity of hollow of the wheel.

11. A method of stably stacking a plurality of bicycle wheels of claim 1 for any of facilitated storage, handling and transport, the method comprising the steps of:
a) providing a bicycle wheel with a central hub cavity,
b) forming a separable self contained hub axle cartridge with either the drive components of the front and rear wheel,
c) forming the self contained hub axle cartridge with elements for connection between the wheel and the bicycle frame, and
d) connecting the hub axle cartridge to the wheel and the bicycle frame for use of the bicycle and disconnecting the hub cartridge from the bicycle wheel and bicycle frame for said stacked storage, handling and transport of the bicycle wheels.
